(19) United States
(12) Patent Application Publication
(10) Pub. No.: US 2024/0370456 A1
(43) Pub. Date: Nov. 7, 2024

(54) SIMPLE REFLEX INTELLIGENT AGENT FOR CRAWLING LITERATURE DATA AND METHOD OF CRAWLING LITERATURE DATA

(71) Applicant: CENTRAL SOUTH UNIVERSITY, Changsha (CN)

(72) Inventors: Jun LONG, Changsha (CN); Tingxuan CHEN, Changsha (CN); Liu YANG, Changsha (CN); Qianqian QI, Changsha (CN); Zidong WANG, Changsha (CN)

(21) Appl. No.: 18/777,105

(22) Filed: Jul. 18, 2024

Related U.S. Application Data
(63) Continuation-in-part of application No. PCT/CN2023/100350, filed on Jun. 15, 2023.

(30) Foreign Application Priority Data
Feb. 9, 2023 (CN) 202310086593.7

(51) Int. Cl. G06F 16/26; G06F 16/28

(52) U.S. Cl. CPC G06F 16/26; G06F 16/285

(57) ABSTRACT

The present disclosure discloses a simple reflex intelligent agent for crawling literature data and a method for crawling literature data. The simple reflex intelligent agent includes a performance module, an environment module, a sensing module and an actuator module; the performance module is used to construct a performance objective function; the environment module constructs an environment collection for the simple reflex intelligent agent; the sensing module monitors whether system time and a number of journals have been changed; the actuator module sets targets based on the performance objective function and automatically crawls literature data.

### CROSS-REFERENCE TO RELATED APPLICATION

This application is a continuation-in-part of and claims priority to International Patent Application No. PCT/CN2023/100350 filed on Jun. 15, 2023, which application claims the benefit and priority of Chinese Patent Application No. 202310086593.7 filed with the China National Intellectual Property Administration on Feb. 9, 2023, and entitled “simple reflex intelligent agent for crawling literature data and method of crawling literature data”. The two applications are incorporated by reference herein in the entirety as part of the present application.

### TECHNICAL FIELD

The present disclosure relates to the field of Internet technology, and specifically to a simple reflex intelligent agent for crawling literature data and a method of crawling literature data.

### BACKGROUND

Technology literature data not only reflects the academic accomplishment of a researcher, but is also a core indicator for assessing the school-running strength of universities and colleges. With the passage of time and the development of Internet technology, technology literature data show explosive growth, and the impact factor of academic journals changes dynamically. Therefore, it has become an urgent problem to be solved to efficiently obtain technology literature data in real time for supporting disciplinary assessment and scholars' profiling.

Conventional web crawlers are designed to simulate user actions on a browser and automatically extract valuable web data to the user from a specific website. As the data acquisition by web crawlers will bring the same consumption of website resources as the real user's access, the data acquisition by web crawlers especially for a website such as Web of Science storing huge amount of technology literature data, would consume much larger resources than the real user's access.

Conventional anti-crawler strategies for dealing with Web of Science websites mainly rely on manual operations, such as manually reducing the access frequency of web crawler tools, resetting the IP address of web crawlers, and using manual human-computer verification. Manual operation not only requires staff to have certain professional knowledge and business quality, but also consumes a lot of time, which in turn affects the speed, accuracy and comprehensiveness of obtaining technology literature data.

In summary, there is an urgent need for a simple reflex intelligent agent and method for crawling literature data to solve the problems in the prior art.

### SUMMARY

An object of the present disclosure is to provide a simple reflex intelligent agent for crawling literature data and a method of crawling literature data, with the following specific technical solutions:

A simple reflex intelligent agent for crawling literature data, includes a performance module, an environment module, a sensing module, and an actuator module;
where the performance module is configured to construct a performance objective function, and the performance objective function is constructed by: constructing a comprehensiveness indicator for the simple reflex intelligent agent using the number of published papers in journals in a target database as a benchmark; analyzing characteristics of the literature data in the target database to construct a accuracy indicator for the simple reflex intelligent agent; establishing the performance objective function based on the comprehensiveness indicator and the accuracy indicator;
the environment module is configured to analyze periodic characteristics of literature data updates in the journals and construct an environment collection of the simple reflex intelligent agent;
the sensing module monitors whether a system time and a number of journals have been changed based on the environment collection; and
the actuator module sets a target based on the performance objective function and automatically crawls the literature data in an operating environment of the simple reflex intelligent agent.

Preferably, an expression for the comprehensiveness indicator is as follows:

$${AR}_{p} = {\sum }_{( {t}_{i} , {c}_{i} ) ∈ {S}_{p}} argmax exp ( {\vert {x}_{i} - {c}_{i} \vert}_{2}^{2} ) ;$$

where ARₚ is the comprehensiveness indicator to evaluate automatic crawling of the simple reflex intelligent agent on the literature data; xᵢ denotes a number of the literature data of a journal i automatically crawled by the simple reflex intelligent agent; |⋅|₂² denotes a 2 paradigm distance function, cᵢ is a number of published literature data of the journal i in a time span tᵢ.

Preferably, an expression for the accuracy indicator is as follows:

$${AC}_{p} = {\sum }_{( {t}_{i} , {c}_{i} ) ∈ {S}_{p}} {\sum }_{j = 1}^{x} arg max exp ( {\vert [ {p}_{( i , j )} ] - β \vert}_{2}^{2} ) ;$$

where ACₚ is the accuracy indicator to evaluate the automatic crawling of the simple reflex intelligent agent on the literature data, p_{(i,j)} denotes a j^{th} literature data of the journal i automatically crawled by the simple reflex intelligent agent; [p_{(i,j)}] denotes data characteristics of the literature data p_{(i,j)}, and β represents data characteristics of the literature data in the target database.

Preferably, an expression for the performance objective function is as follows:

$${ℒ}_{p} = arg min ( log ( {AR}_{p} ) + log ( {AC}_{p} ) ) ;$$

where [symbol] ₚ is the performance objective function to evaluate the automatic crawling of the simple reflex intelligent agent on the literature data.

Preferably, an expression for the environment collection is as follows:

$${S}_{p} = \{ ( {t}_{i} , {c}_{i} ) \vert i ∈ N \} ;$$

where Sₚ denotes the environment collection, tᵢ is the time span over which the journal i is updated in the target database, cᵢ is the number of published literature data of the journal i in the time span tᵢ, and N is a number of the journals in the target database.

Preferably, the sensing module continuously monitors the system time and the number of journals in the environment collection with a following expression:

$${M}_{p} = {\sum }_{( {t}_{i} , {c}_{i} ) ∈ {S}_{p}} max \{ ( T - {t}_{i} ) , ( {N}^{*} - N ) , 0 \} ;$$

where Mₚ is used to reflect a change in the system time and the number of journals, and Mₚ>0 indicates that there exits a change in the system time and the number of journals, T denotes a current system time monitored by the sensing module, and N* is a number of latest journals in the target database monitored by the sensing module.

Preferably, the simple reflex intelligent agent further includes a storage module, configured for storing crawled literature data and log information during crawling of the literature data.

In addition, the present disclosure further includes a method for crawling literature data, applied in the above-mentioned simple reflex intelligent agent to crawl the literature data, when the sensing module monitors a change in the system time and the number of journals, the actuator module sets a target based on the performance objective function constructed by the performance module and automatically crawls the literature data.

Application of the technical solutions of the present disclosure has the following beneficial effects:

The present disclosure implements literature data crawling by constructing a simple reflex intelligent agent for crawling literature data. The simple reflex intelligent agent can achieve comprehensive and accurate literature data crawling by establishing a comprehensiveness indicator and an accuracy indicator of literature data, constructing a performance objective function based on the comprehensiveness indicator and the accuracy indicator, and setting targets based on the performance objective function via an actuator module.

In addition to the purposes, features and advantages described above, the present disclosure has other purposes, features and advantages. The present disclosure will be described in further detail below with reference to the drawings.

### BRIEF DESCRIPTION OF THE DRAWINGS

The accompanying drawings, which form part of this application, are used to provide a further understanding of the present disclosure, and the schematic embodiments of the disclosure and the description thereof are used to explain the present disclosure and do not constitute an improper limitation of the present disclosure. In the accompanying drawings:

FIG. 1 is a schematic diagram of a paper intelligent agent performing paper information crawling in preferred embodiment 1 of the present disclosure;

FIG. 2 is a schematic diagram of an impact factor intelligent agent performing impact factor crawling in the preferred embodiment 2 of the present disclosure;

FIG. 3 illustrates a schematic diagram of a computing system 300 according to embodiments.

### DETAILED DESCRIPTION OF THE EMBODIMENTS

Conventional anti-crawler strategies for dealing with Web of Science mainly rely on manual operations, such as manually reducing the access frequency of web crawler tools, resetting the IP address of web crawlers, using manual human-computer verification, etc. Manual operation not only requires staff to have certain professional knowledge and business quality, but also requires to consume a lot of time, which in turn affects the speed, accuracy and comprehensiveness of obtaining technology literature data.

In order to overcome the deficiencies of the above mentioned related art, the present disclosure provides a simple reflex intelligent agent and method for crawling literature data, in order to solve the technical problems of existing web crawlers crawling technology literature data that require manual intervention, incomplete data crawling, and low accuracy of data crawling.

Embodiments of the disclosure are described in detail below in conjunction with the accompanying drawings, but the disclosure may be implemented in various different ways as defined and covered by the claims.

### Embodiment 1

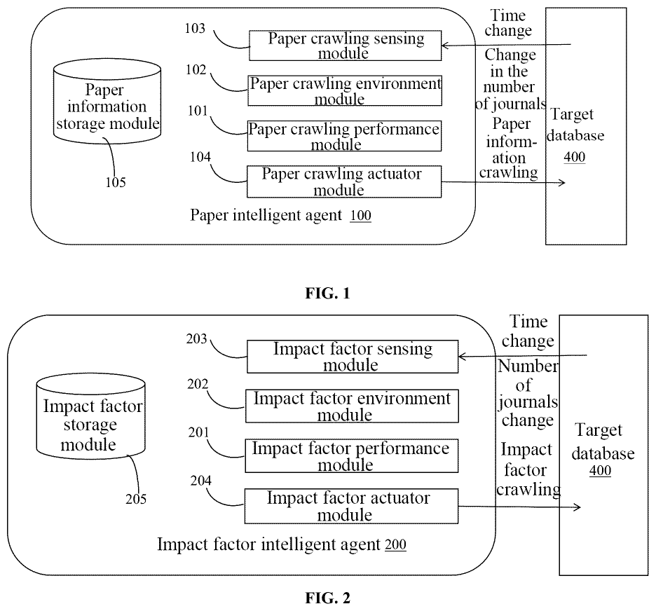

As shown in FIG. 1, this embodiment discloses a simple reflex intelligent agent for crawling literature data, in particular a paper intelligent agent 100 for crawling paper information. The paper intelligent agent 100 includes a paper crawling performance module 101, a paper crawling environment module 102, a paper crawling sensing module 103, a paper crawling actuator module 104, and a paper information storage module 105. In addition, a target database 400 crawled by this embodiment is a Web of Science database.

Herein, the paper crawling performance module 101 is configured to construct a paper information crawling performance objective function, and the paper information crawling performance objective function is constructed by: taking the number of the published papers of journals in the Web of Science database as a benchmark to construct a paper information crawling comprehensiveness indicator of the paper intelligent agent 100; analyzing field information included in each paper in the Web of Science database to construct a paper information crawling accuracy indicator of the paper intelligent agent 100; establishing the paper information crawling performance objective function based on the comprehensiveness indicator and the accuracy indicator.

The field information of the paper in this embodiment includes literature title, literature type, language, keywords, abstract, references, reference quantity, Digital object identifier, author, corresponding author's address, Research ID, publication name, publisher, publication date, etc.

The paper crawling environment module 102 is configured to analyze the number of the published papers of journals and the periodic characteristics of Web of Science database updates, and to construct a paper information environment collection for the paper intelligent agent 100.

The paper crawling sensing module 103 continuously monitors whether the system time and the number of journals in the operating environment of the paper intelligent agent 100 have been changed.

The paper crawling actuator module 104 is configured to automatically crawl the paper information in the operating environment of the paper intelligent agent 100.

The paper information storage module 105 is configured to store the crawled paper information and log information during the crawling process.

Further, the expression for the paper information crawling comprehensiveness indicator is as follows:

$${AR}_{p} = {\sum }_{( {t}_{i} , {c}_{i} ) ∈ {S}_{p}} arg max exp ( {\vert {x}_{i} - {c}_{i} \vert}_{2}^{2} ) ;$$

Where ARₚ is the paper information crawling comprehensiveness indicator to evaluate the automatic crawling of the paper intelligent agent 100 on the paper information, xᵢ denotes the number of papers in journal i automatically crawled by the paper intelligent agent 100, cᵢ is the number of papers of the journal i published in a time span tᵢ, and |⋅|₂² denotes a 2 paradigm distance function. As values of xᵢ and cᵢ are more approximate to each other, the number of papers in the journal i automatically crawled by the paper intelligent agent 100 is more approximate to the number of the published papers of the journal i in the Web of Science database. The paper information automatically crawled by the paper intelligent agent 100 is more comprehensive as the value of ARₚ decreases.

Further, the expression for the paper information crawling accuracy indicator is as follows:

$${AC}_{p} = {\sum }_{( {t}_{i} , {c}_{i} ) ∈ {S}_{p}} {\sum }_{j = 1}^{{x}_{i}} arg max exp ( {\vert [ {p}_{( i , j )} ] - β \vert}_{2}^{2} ) ;$$

Where ACₚ is the paper information crawling accuracy indicator to evaluate the automatic crawling of the paper intelligent agent 100 on the paper information, p_{(i,j)} denotes the j^{th} literature data of the journal i automatically crawled by the simple reflex intelligent agent, [p_{(i,j)}] denotes the number of fields included in the literature data p_{(i,j)}, and β denotes the number of fields of literature data in the Web of Science database. For example, see Table 1, in 2021, each paper in the Web of Science database included 70 field information, such as literature title, literature type, language, keywords, etc., i.e., β=70.

TABLE 1
Information on some of the fields of the paper crawled by the paper
intelligent agent 100
Paper Information

| | | | |
|---|---|---|---|
| TI | Literature title | TC | Cited frequency Counts |
| | | | for the Web of Science |
| | | | Core Collection |
| LA | Language | Z9 | Total cited frequency: |
| | | | Web of Science Core |
| | | | Collection, BIOSIS |
| | | | Citation Index, Chinese |
| | | | Science Citation Database, |
| | | | Data Citation Index, Russian |
| | | | Science Citation Index, |
| | | | Citation Index |
| DT | Literature type (article, | U1 | Usage frequency |
| | proceeings of paper) | | (last 180 days) |
| ID | Keywords plus (keywords | U2 | Usage frequency |
| | extracted from the titles of | | (2013-present) |
| | the article's references) | | |
| AB | Abstracts | AR | Literature number |
| CR | References cited | BP | Begin page |
| NR | Number of references cited | EP | End page |
| DI | Digital object identifier | PG | Pages |
| | (DOI) | | |
| AU | Author | DE | Keywords |
| AF | Author's full name | C1 | Author Address |
| RP | Corresponding Author | EM | E-mail address |
| | Address | | |
| RI | Researcher ID | OI | ORCID identifier |
| S0 | Publication name | PT | Publication type |
| | | | (J = Journal; B = Book; |
| | | | S = Series; P = Patent) |
| PU | Publisher | SN | International Standard |
| | | | Serial Number (ISSN) |
| PD | Publication date | PY | Publication year |
| VL | Volume | IS | Issue |

Further, the expression for the paper information crawling performance objective function is as follows:

$${ℒ}_{p} = arg min ( log ( {AR}_{p} ) + log ( {AC}_{p} ) ) ;$$

Where [symbol] ₚ is the paper information crawling performance objective function to evaluate the automatic crawling of the paper intelligent agent 100 on the paper information. The paper intelligent agent 100 would automatically crawl the paper information more comprehensively and accurately with decrease of the [symbol] ₚ value.

Further, an expression of the paper information environment collection expression is as follows:

$${S}_{p} = \{ ( {t}_{i} , {c}_{i} ) \vert i ∈ N \} ;$$

Where Sₚ denotes the paper information environment collection, tᵢ is the time span over which the paper information of the journal i has been updated in the Web of Science database, cᵢ is the number of published papers of the journal i in the time span tᵢ, and N is the number of journals in the Web of Science database. For example, the value of N was 12424 in 2021, which means that the Web of Science database stores a total of 12,424 journals, and for the 23^{rd} journal, PRL (Pattern Recognition Letters), a total of 373 papers were published during 2021, i.e., t₂₃=2021 and c₂₃=373.

Further, the sensing module continuously monitors the change in the system time and the number of journals in the environment collection with the following expression:

$${M}_{p} = {\sum }_{( {t}_{i} , {c}_{i} ) ∈ {S}_{p}} max \{ ( T - {t}_{i} ) , ( {N}^{*} - N ) , 0 \} ;$$

Where Mₚ is used to reflect the change in the system time and the number of journals, T denotes a current system time monitored by the sensing module, and N* is the latest number of journals in the Web of Science database monitored by the sensing module. When the current system time monitored by the sensing module is greater than the time span of the journal update or a new journal is added to the Web of Science database, Mₚ>0. When Mₚ>0, it indicates a change in the system time and the number of journals.

Further, this embodiment also discloses a literature data crawling method, in particular a paper crawling method, applying the paper intelligent agent 100 as described above to crawl paper information. When the sensing module monitors a change in the system time and the number of journals, the actuator module sets a target based on the performance objective function constructed by the performance module and automatically crawls the paper information in the operating environment of the paper intelligent agent 100.

The paper crawling method disclosed in this embodiment constructs a paper crawling performance objective function by means of the paper information crawling accuracy indicator and the paper information crawling comprehensiveness indicator, which ensures that the paper information is crawled accurately and comprehensively, reduces manual intervention, and increases the efficiency in crawling the paper information.

Further, this embodiment employs the above-described paper intelligent agent 100 to crawl paper information data of a total of five years from 2017-2021 from the Web of Science database.

TABLE 2
Results of crawling paper information

| | | Number of | Original | | |
|---|---|---|---|---|---|
| Serial | | crawled | number in | Missing | Missing |
| No. | Year | papers | ESI database | number | percentage |
| 1 | 2021 | 3542466 | 3556653 | 14187 | 0.00 |
| 2 | 2020 | 3256224 | 3267731 | 11507 | 0.00 |
| 3 | 2019 | 2977932 | 3004042 | 26110 | 0.01 |
| 4 | 2018 | 2693610 | 2730336 | 36726 | 0.01 |
| 5 | 2017 | 2566642 | 2624542 | 57900 | 0.02 |

As detailed in Table 2, the actuator module in this crawling result sets the target of [symbol] ₚ≤0.02, in which none of the crawling failures exceeds 0.02.

### Embodiment 2

As shown in FIG. 2, this embodiment discloses a simple reflex intelligent agent for crawling literature data, in particular an impact factor intelligent agent 200 for crawling journal impact factors. The impact factor intelligent agent 200 includes an impact factor crawling performance module 201, an impact factor crawling environment module 202, an impact factor crawling sensing module 203, an impact factor crawling actuator module 204, and an impact factor storage module 205. In addition, the target database 400 crawled in this embodiment is the Web of Science database.

Herein, the impact factor crawling performance module 201 is configured to construct an impact factor crawling performance objective function, and the impact factor crawling performance objective function is constructed by: taking the number of journals in the Web of Science database as a benchmark to construct an impact factor crawling comprehensiveness indicator of the impact factor intelligent agent 200; analyzing impact factor change of journals in the Web of Science database to construct an impact factor crawling accuracy indicator of the impact factor intelligent agent 200; and establishing the impact factor crawling performance objective function based on the comprehensiveness indicator and the accuracy indicator.

The impact factor crawling environment module 202 is configured to analyze the impact factor value and update frequency of the journal, and to construct an impact factor environment collection of the impact factor intelligent agent 200.

The impact factor crawling sensing module 203 continuously monitors whether the system time and the number of journals in the operating environment of the impact factor intelligent agent 200 have been changed.

The impact factor crawling actuator module 204 is configured to automatically crawl the impact factor in the operating environment of the impact factor intelligent agent 200.

The impact factor storage module 205 is configured to store the crawled impact factor and log information during the crawling process.

Further, the expression for the impact factor crawling comprehensiveness indicator is as follows:

$${AR}_{f} = arg max exp ( {\vert {N}^{′} - N \vert}_{2}^{2} ) ;$$

Where AR_{f} is the comprehensiveness indicator to evaluate the automatic crawling of the impact factor intelligent agent 200 on the impact factor, N′ denotes the number of journal impact factors crawled automatically by the impact factor intelligent agent 200, and |⋅|₂² denotes the 2 paradigm distance function. As values of N′ and N are more approximate to each other, the number of journal impact factors automatically crawled by the impact factor intelligent agent 200 is more approximate to the number of journal impact factors in the Web of Science database. The journal impact factor automatically crawled by the impact factor intelligent agent 200 is more comprehensive as the value of AR_{f} decreases.

Further, the expression for the impact factor crawling accuracy indicator is as follows:

$${AC}_{f} = {\sum }_{( {τ}_{i} , {e}_{i} ) ∈ {S}_{f}} {\sum }_{i = 1}^{{N}^{′}} arg max exp ( {\vert {y}_{i} - {e}_{i} \vert}_{2}^{2} ) ;$$

Where AC_{f} is the accuracy indicator to evaluate the automatic crawling of the impact factor intelligent agent 200 on the journal impact factor, and yᵢ denotes the value of the journal impact factor crawled automatically by the impact factor intelligent agent 200. As yᵢ is more approximate to eᵢ, the journal impact factor crawled automatically by the impact factor intelligent agent 200 is more accurate. The journal impact factor automatically crawled by the impact factor intelligent agent 200 is more accurate as the value of AC_{f} decreases.

Further, the expression for the impact factor crawling performance objective function is as follows:

$${ℒ}_{f} = arg min ( log ( {AR}_{f} ) + log ( {AC}_{f} ) ) ;$$

Where [symbol] _{f} is the impact factor crawling performance objective function to evaluate the automatic crawling of the impact factor intelligent agent 200 on the impact factor. The journal impact factor automatically crawled by the impact factor intelligent agent 200 is more comprehensive and accuracy with decrease of the [symbol] _{f} value.

Further, the expression for the impact factor environment collection is as follows:

$${S}_{f} = \{ ( {τ}_{i} , {e}_{i} ) \vert i ∈ N \} ;$$

Where S_{f} denotes a collection of external environments in which the impact factor intelligent agent 200 operates, τᵢ is a time span over which the impact factor of the journal i is updated in the Web of Science database, eᵢ is a value for the impact factor of the journal i over the time span τᵢ, and N is the number of journals in the Web of Science database. For example, the value of N is 12424 in 2021, which means that the Web of Science database stores a total of 12424 journals, and for the 23^{rd} journal, PRL (Pattern Recognition Letters), its impact factor is updated every 12 months and it has an impact factor of 4.757 in 2021, i.e., τ₂₃=12 and e₂₃=4.757.

Further, the sensing module continuously monitors the change in the system time and the number of journals in the environment collection with the following expression:

$${M}_{f} = {\sum }_{( {τ}_{i} , {c}_{i} ) ∈ {S}_{f}} max \{ ( T - {τ}_{i} ) , ( {N}^{*} - N ) , 0 \} ;$$

Where M_{f} is used to reflect the change in the system time and the number of journals, and when M_{f}>0, it indicates a change in the system time and the number of journals.

Further, this embodiment also discloses a literature data crawling method, in particular an impact factor crawling method, applying the impact factor intelligent agent 200 as described above to crawl the impact factor. When the sensing module has monitored a change in the system time and the number of journals, the actuator module sets a target based on the performance objective function constructed by the performance module and automatically crawls the impact factor.

Further, in this embodiment, if the sensing module monitors M_{f}>0, the actuator module is activated, automatically crawls the impact factors of journals in the Web of Science database based on the impact factor environment collection with the target of [symbol] _{f}≤0.02.

TABLE 3
Crawling results of impact factor

| | | Number of crawled | Original | | |
|---|---|---|---|---|---|
| Serial | | journal impact | number in | Missing | Missing |
| No. | Year | factors | ESI database | number | percentage |
| 1 | 2021 | 12424 | 12424 | 0 | 0.00 |
| 2 | 2020 | 12167 | 12167 | 0 | 0.00 |
| 3 | 2019 | 9152 | 9152 | 0 | 0.00 |
| 4 | 2018 | 8344 | 8344 | 0 | 0.00 |
| 5 | 2017 | 8192 | 8192 | 0 | 0.00 |

As shown in Table 3, in this embodiment, journal impact factor data of a total of five years from 2017-2021 from the Web of Science database are crawled.

As can be seen through Table 3, the percentage of impact factor crawling failures is zero. It can be seen that journal impact factor crawling according to the embodiment ensures the stability and comprehensiveness of the crawling results.

It can be clearly understood by those skilled in the art that for the convenience and conciseness of description, only the division of the functional modules are taken as an example. In practical application, the functions can be allocated by different functional modules as required. That is, the internal structure of the intelligent agent is divided into different functional modules. The integrated modules can be realized in the form of hardware or software functional units. In addition, the specific name of each functional module is only for conveniently distinguishing each other, and is not used to limit the scope of protection of the present disclosure.

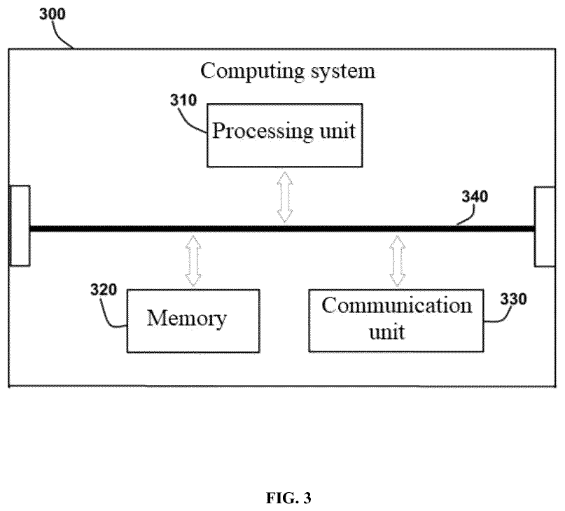

FIG. 3 illustrates a schematic diagram of a computing system 300 according to embodiments. Specifically, FIG. 3 illustrates a schematic diagram of a computing system 300 configured to run the intelligent agent of the present application or to perform methods discussed herein. The computing system 300 may, for example, be a terminal such as a personal computer, and a user may realize access to the Web of Science website through the computing system 300.

As shown in FIG. 3, the computing system 300 includes a processing unit or processor 310, a memory 320, and a communication unit 330. The processing unit 310, memory 320, and communication unit 330 may be connected via a bus system 340. The memory 320 is configured to store programs, instructions, or code, such as programs, instructions, or code corresponding to the crawling performance module, the crawling environment module, the crawling sensing module, the crawling actuator module, the storage module, and a literature data crawling method.

The processing unit 310 is configured to execute programs, instructions, or code stored in memory 320 in order to accomplish the operation of the various modules or steps discussed herein. For example, the steps and operations discussed herein may be executed or implemented by the processor 310 via the communication unit 330. The communication unit 330 may be a transceiver or other suitable interface to implement the relevant operations discussed herein. The processing unit 310, via the communication unit 330, may implement access to a network such as, for example, the Web of Science website, and implement crawling literature data from the Web of Science website by running stored programs, instructions, or code in the memory 320.

For example, the processor 310 may include one or more central processing units (CPUs) or general-purpose processors with one or more processing cores, although other types of processors may also be used.

In some embodiments, the memory 320 is further configured to store information about the crawled papers, the impact factors, and log information during the crawling process.

The foregoing is merely a preferred embodiment of the present disclosure and is not intended to limit the disclosure, which is subject to various changes and variations of the present disclosure for those skilled in the art. Any modifications, equivalent substitutions, improvements made within the spirit and principles of the present disclosure shall be included in the protection scope of the present disclosure.

What is claimed is:

1. A simple reflex intelligent agent for crawling literature data, comprising a performance module, an environment module, a sensing module, and an actuator module;
wherein the performance module is configured to construct a performance objective function, and the performance objective function is constructed by: constructing a comprehensiveness indicator for the simple reflex intelligent agent using a number of published papers in journals in a target database as a benchmark; analyzing characteristics of the literature data in the target database to construct a accuracy indicator for the simple reflex intelligent agent; establishing the performance objective function based on the comprehensiveness indicator and the accuracy indicator;
the environment module is configured to analyze periodic characteristics of literature data updates in the journals and construct an environment collection of the simple reflex intelligent agent;
the sensing module monitors whether a system time and a number of journals have been changed based on the environment collection; and
the actuator module sets a target based on the performance objective function and automatically crawls the literature data in an operating environment of the simple reflex intelligent agent.

2. The simple reflex intelligent agent according to claim 1, wherein an expression for the comprehensiveness indicator is as follows:
$${AR}_{p} = {\sum }_{( {t}_{i} , {c}_{i} ) ∈ {S}_{p}} arg max exp ( {\vert {x}_{i} - {c}_{i} \vert}_{2}^{2} ) ;$$
wherein ARₚ is the comprehensiveness indicator to evaluate automatic crawling of the simple reflex intelligent agent on the literature data; xᵢ denotes a number of the literature data of a journal i automatically crawled by the simple reflex intelligent agent; |⋅|₂² denotes a 2 paradigm distance function, cᵢ is a number of published literature data of the journal i in a time span tᵢ, and Sₚ denotes the environment collection.

3. The simple reflex intelligent agent according to claim 2, wherein an expression for the accuracy indicator is as follows:
$${AC}_{p} = {\sum }_{( {t}_{i} , {c}_{i} ) ∈ {S}_{p}} {\sum }_{j = 1}^{{x}_{i}} arg max exp ( {\vert [ {p}_{( i , j )} ] - β \vert}_{2}^{2} ) ;$$
wherein ACₚ is the accuracy indicator to evaluate the automatic crawling of the simple reflex intelligent agent on the literature data, p_{(i,j)} denotes a j^{th} literature data of the journal i automatically crawled by the simple reflex intelligent agent; [p_{(i,j)}] denotes data characteristics of the literature data p_{(i,j)}, and β represents data characteristics of the literature data in the target database.

4. The simple reflex intelligent agent according to claim 3, wherein an expression for the performance objective function is as follows:
$${ℒ}_{p} = arg min ( log ( {AR}_{p} ) + log ( {AC}_{p} ) ) ;$$
wherein [symbol] ₚ is the performance objective function to evaluate the automatic crawling of the simple reflex intelligent agent on the literature data.

5. The simple reflex intelligent agent according to claim 4, wherein an expression for the environment collection is as follows:
$${S}_{p} = \{ ( {t}_{i} , {c}_{i} ) \vert i ∈ N \} ;$$
wherein Sₚ denotes the environment collection, tᵢ is the time span over which the journal i is updated in the target database, cᵢ is the number of published literature data of the journal i in the time span tᵢ, and N is a number of the journals in the target database.

6. The simple reflex intelligent agent according to claim 5, wherein the sensing module continuously monitors the system time and the number of journals in the environment collection with a following expression:
$${M}_{p} = {\sum }_{( {t}_{i} , {c}_{i} ) ∈ {S}_{p}} max \{ ( T - {t}_{i} ) , ( {N}^{*} - N ) , 0 \} ;$$
where Mₚ is used to reflect a change in the system time and the number of journals, and Mₚ>0 indicates that there exits a change in the system time and the number of journals, T denotes a current system time monitored by the sensing module, and N* is a number of latest journals in the target database monitored by the sensing module.

7. The simple reflex intelligent agent according to claim 1, further comprising a storage module, configured for storing crawled literature data and log information during crawling of the literature data.

8. A method for crawling literature data, comprising:
constructing a comprehensiveness indicator for the simple reflex intelligent agent using a number of published papers in journals in a target database as a benchmark;
analyzing characteristics of the literature data in the target database to construct a accuracy indicator for the simple reflex intelligent agent;
establishing a performance objective function based on the comprehensiveness indicator and the accuracy indicator;
analyzing periodic characteristics of literature data updates in the journals and constructing an environment collection of the simple reflex intelligent agent;
monitoring whether a system time and a number of journals have been changed based on the environment collection; and
setting a target based on the performance objective function and automatically crawling the literature data in an operating environment of the simple reflex intelligent agent when a change in the system time and the number of journals is monitored.

9. The method according to claim 8, wherein an expression for the comprehensiveness indicator is as follows:
$${AR}_{p} = {\sum }_{( {t}_{i} , {c}_{i} ) ∈ {S}_{p}} arg max exp ( {\vert {x}_{i} - {c}_{i} \vert}_{2}^{2} ) ;$$
wherein ARₚ is the comprehensiveness indicator to evaluate automatic crawling of the simple reflex intelligent agent on the literature data; xᵢ denotes a number of the literature data of a journal i automatically crawled by the simple reflex intelligent agent; |⋅|₂² denotes a 2 paradigm distance function, cᵢ is a number of published literature data of the journal i in a time span tᵢ, and Sₚ denotes the environment collection.

10. The method according to claim 9, wherein an expression for the accuracy indicator is as follows:
$${AC}_{p} = {\sum }_{( {t}_{i} , {c}_{i} ) ∈ {S}_{p}} {\sum }_{j = 1}^{{x}_{i}} arg max exp ( {\vert [ {p}_{( i , j )} ] - β \vert}_{2}^{2} ) ;$$
wherein ACₚ is the accuracy indicator to evaluate the automatic crawling of the simple reflex intelligent agent on the literature data, p_{(i,j)} denotes a j^{th} literature data of the journal i automatically crawled by the simple reflex intelligent agent; [p_{(i,j)}] denotes data characteristics of the literature data p_{(i,j)}, and β represents data characteristics of the literature data in the target database.

11. The method according to claim 10, wherein an expression for the performance objective function is as follows:
$${ℒ}_{p} = arg min ( log ( {AR}_{p} ) + log ( {AC}_{p} ) ) ;$$
wherein [symbol] ₚ is the performance objective function to evaluate the automatic crawling of the simple reflex intelligent agent on the literature data.

12. The method according to claim 11, wherein an expression for the environment collection is as follows:
$${S}_{p} = \{ ( {t}_{i} , {c}_{i} ) \vert i ∈ N \} ;$$
wherein Sₚ denotes the environment collection, tᵢ is the time span over which the journal i is updated in the target database, cᵢ is the number of published literature data of the journal i in the time span tᵢ, and N is a number of the journals in the target database.

13. The method according to claim 12, wherein the system time and the number of journals are continuously monitored in the environment collection with a following expression:
$${M}_{p} = {\sum }_{( {t}_{i} , {c}_{i} ) ∈ {S}_{p}} max \{ ( T - {t}_{i} ) , ( {N}^{*} - N ) , 0 \} ;$$
where Mₚ is used to reflect a change in the system time and the number of journals, and Mₚ>0 indicates that there exits a change in the system time and the number of journals, T denotes a current system time monitored by the sensing module, and N* is a number of latest journals in the target database monitored by the sensing module.

14. The method according to claim 8, further comprising: storing crawled literature data and log information during crawling of the literature data.
